(19) United States
(12) Patent Application Publication
(10) Pub. No.: US 2025/0367592 A1
(43) Pub. Date: Dec. 4, 2025

(54) HEAT PUMP ASSISTED CARBON CAPTURE FROM INTERNAL COMBUSTION ENGINE POWERED SYSTEMS

(71) Applicant: SAUDI ARABIAN OIL COMPANY, Dhahran (SA)

(72) Inventors: Fethi Khaled, Al-Khobar (SA); Esam Zaki Hamad, Brighton, MI (US)

(73) Assignees: SAUDI ARABIAN OIL COMPANY, Dhahran (SA); ARAMCO SERVICES COMPANY, Houston, TX (US)

(21) Appl. No.: 18/676,625

(22) Filed: May 29, 2024

(51) Int. Cl. B01D 53/14; B01D 53/18; F25B 30/04

(52) U.S. Cl. CPC B01D 53/1475; B01D 53/1418; B01D 53/1425; B01D 53/18; F25B 30/04; B01D 2257/504; B01D 2258/01; B01D 2259/455; B01D 2259/65

(57) ABSTRACT

An exhaust gas carbon dioxide capture and recovery system for an internal combustion engine includes a Mobile Carbon Capture (MCC) system and an absorption heat transformer. The MCC system captures carbon emissions of a first exhaust of the internal combustion engine and includes an exhaust absorber and a stripper. The exhaust absorber extracts at least a portion of carbon dioxide from the first exhaust using a lean solvent stream, and produces a rich solvent stream and a second exhaust having a reduced amount of carbon dioxide. The lean solvent stream includes a solvent selective for absorbing carbon dioxide, and the rich solvent stream includes the solvent and absorbed carbon dioxide. The stripper converts the rich solvent stream into the lean solvent stream and a crude carbon dioxide vapor. The absorption heat transformer provides heat to the stripper by generating a high temperature stream from a heat content of a coolant.

### BACKGROUND

Carbon dioxide emissions accrue from both natural and human sources. Natural sources of carbon dioxide include decomposition, ocean release, and respiration. Human sources of carbon dioxide originate from activities such as deforestation and the burning of fossil fuels, such as coal, oil, and natural gas. Accordingly, vehicles and other mobile machinery contribute to climate change and pollution. As such, zero-emission engines (or near zero-emission engines), which do not release (or only slightly release) greenhouse gases, such as carbon dioxide, methane, and nitrous oxide, to the atmosphere, are an area of active research.

Carbon dioxide emissions from mobile sources, including vehicles and ships, need to be significantly reduced to achieve the goal of zero emission. However, reducing carbon dioxide emissions from mobile sources requires technology and engineering that balances operating and fixed costs while avoiding systems and operations that are overly complex or hinder operation of the mobile source. For example, in the case where a carbon dioxide reduction technology (e.g., a zero-emission engine) requires an unconventional/uncommon energy source or bulky, heavy, and costly equipment to operate, such a technology may reduce the usefulness of the mobile source by making refueling costlier, less convenient, or a lengthier process.

### SUMMARY

In one aspect, one or more embodiments relate to an exhaust gas carbon dioxide capture and recovery system for an internal combustion engine that includes a Mobile Carbon Capture (MCC) system and an absorption heat transformer. The MCC system captures carbon emissions of a first exhaust of the internal combustion engine and includes an exhaust absorber and a stripper. The exhaust absorber extracts at least a portion of carbon dioxide from the first exhaust using a lean solvent stream, and produces a rich solvent stream and a second exhaust having a reduced amount of carbon dioxide. The lean solvent stream includes a solvent selective for absorbing carbon dioxide, and the rich solvent stream includes the solvent and absorbed carbon dioxide. The stripper converts the rich solvent stream into the lean solvent stream and a crude carbon dioxide vapor. Further, the absorption heat transformer provides heat to the stripper by generating a high temperature stream from a heat content of a coolant. The high temperature stream includes a temperature greater than the coolant.

In one aspect, one or more embodiments relate to a method for capturing and recovering carbon dioxide from an internal combustion engine. The method includes generating, by an absorption heat transformer, a high temperature stream from a heat content of a coolant and providing, by the high temperature stream, heat to a stripper of an MCC system that captures carbon emissions of a first exhaust of the internal combustion engine. In addition, the method includes extracting, by an exhaust absorber of the MCC system, at least a portion of carbon dioxide from the first exhaust using a lean solvent stream and producing, by the exhaust absorber, a rich solvent stream and a second exhaust having a reduced amount of carbon dioxide. The lean solvent stream includes a solvent selective for absorbing carbon dioxide, and the rich solvent stream includes the solvent and absorbed carbon dioxide. Further, the method includes converting, by the stripper of the MCC system, the rich solvent stream into the lean solvent stream and a crude carbon dioxide vapor.

Other aspects of the present invention will be apparent from the following description and claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 shows a mobile vehicle with a mounted exhaust gas carbon dioxide capture and recovery system in accordance with one or more embodiments of the present disclosure.

FIG. 2 shows an exhaust gas carbon dioxide capture and recovery system in accordance with one or more embodiments of the present disclosure.

FIG. 3 shows a flow diagram of a Mobile Carbon Capture (MCC) system in accordance with one or more embodiments of the present disclosure.

FIG. 4 shows an absorption heat transformer in accordance with one or more embodiments of the present disclosure.

FIG. 5 shows an absorption heat transformer in accordance with one or more embodiments of the present disclosure.

FIG. 6 shows an exemplary embodiment of an absorption zone and a desorption zone of an MCC system according to one or more embodiments of the present disclosure.

FIG. 7 shows a flowchart of a method in accordance with one or more embodiments of the present disclosure.

### DETAILED DESCRIPTION

Specific embodiments of the disclosure will now be described in detail with reference to the accompanying figures. In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments described herein are directed towards systems and methods for capturing and recovering carbon dioxide from an internal combustion engine. The techniques discussed in this disclosure are beneficial in reducing the overall carbon intensity of an internal combustion engine by capturing a large percentage of carbon dioxide from an exhaust of the internal combustion engine. Previous solutions in the industry utilize the heat in the exhaust flow of the internal combustion engine which leads to low carbon capture potential. Alternatively, previous solutions use a separate reboiler to provide additional heat to increase the achievable carbon capture rates, thereby leading to increased operating expenses. However, the techniques discussed in this disclosure advantageously upgrade wasted heat from a coolant of the internal combustion engine to very high temperatures and use this upgraded heat to increase the achievable carbon capture rates of the system. Thus, the techniques discussed in this disclosure are beneficial in increasing an achievable carbon capture rate by providing additional heat to the system without the need to burn extra fuel.

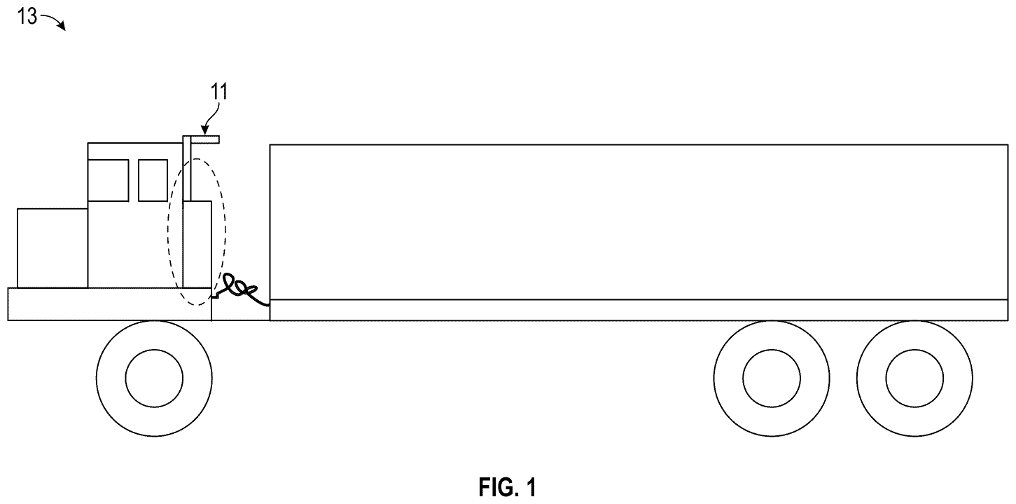

FIG. 1 shows an example of a system according to embodiments herein as part of a mobile, self-propelled vehicle. In particular, FIG. 1 depicts a mobile vehicle with a permanently-mounted exhaust gas carbon dioxide capture and recovery system 11. Here, the mobile, self-propelled vehicle is depicted as a semi-truck 13 that emits carbon dioxide through an exhaust stream that may be treated by embodiment exhaust gas carbon dioxide capture and recovery systems 11 herein. Examples of such mobile vehicles or vessels include, but are not limited to, cars, trucks, gensets, ships, and airplanes. In FIG. 1, the semi-truck 13 is shown with an embodiment of a system mounted to the rear portion of semi-truck 13. The semi-truck 13 is representative of a type of mobile, self-propelled vehicle, in this case being a class-8 truck towing a semi-trailer. While described herein with respect to use with mobile on-road sources, embodiments herein may also be useful for capturing carbon dioxide from off-road sources as well as stationary sources, such as generators. These machines all emit carbon dioxide, have relatively high-quality waste heat that can be used for solvent regeneration, and may produce rotating shaft work that may be utilized. For example, generator sets, locomotives, and agricultural and construction equipment that may be powered by internal combustion engines may also benefit from embodiments herein.

Mobile vehicles with an exhaust gas carbon dioxide capture and recovery system 11 as described herein are not limited to vehicles or vessels that are self-propelled. Embodiment exhaust gas carbon dioxide capture and recovery systems 11 herein may also be mounted on mobile yet non-self-propelled vehicles and vessels, such as a towed barge, a land- or water-borne skiff, or a land- or water-borne drilling platform or “rig”. The mobile unit is configured to be moved and to supply an exhaust stream to the embodiment exhaust gas carbon dioxide capture and recovery system 11 for concentrated pressurized carbon dioxide recovery.

One or more embodiments of the present disclosure relate to capturing and recovering carbon dioxide from a mobile source, such as a car, a truck, a bus, a ship, or a train. Mobile vehicles with one or more embodiments of the exhaust gas carbon dioxide capture and recovery systems 11 are not limited to vehicles or vessels that are self-propelled. Embodiments of the exhaust gas carbon dioxide capture and recovery system 11 may also be mounted on mobile yet non-self-propelled vehicles and vessels, such as a towed barge, a land- or water-borne skiff, or a land- or water-borne drilling platform or “rig,” a generator, or any other engine, turbine, or other equipment producing a hot exhaust stream containing carbon dioxide. The mobile unit is configured to be moved and to supply an exhaust stream to the exhaust gas carbon dioxide capture and recovery system 11 for concentrated pressurized carbon dioxide recovery.

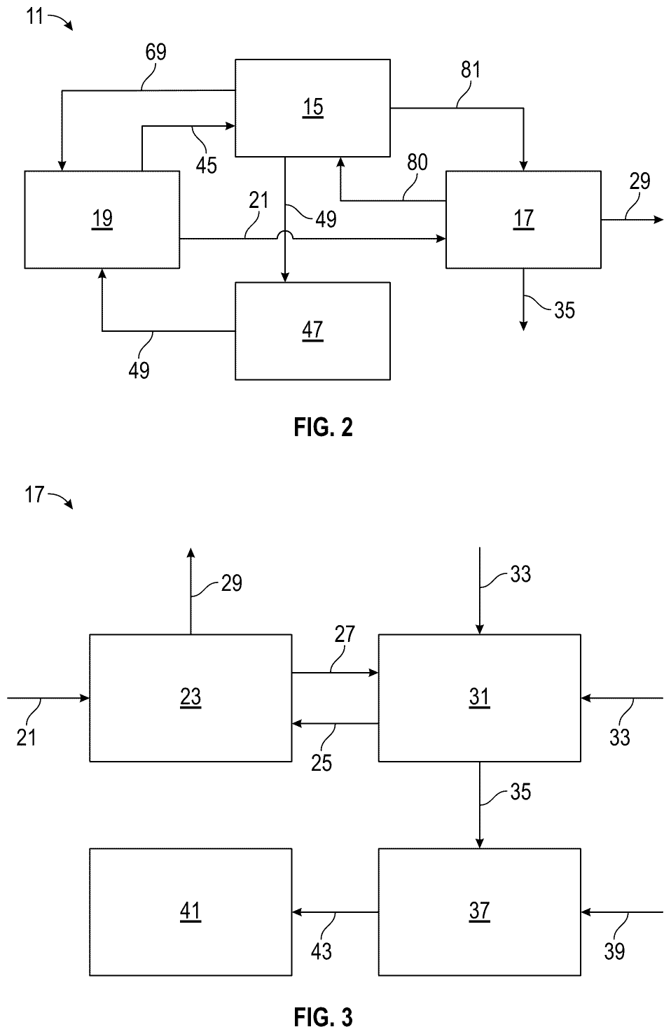

It is envisioned that the exhaust gas carbon dioxide capture and recovery system 11 may be retrofitted to existing mobile sources. Various components of the exhaust gas carbon dioxide capture and recovery system 11 may be integrated into a mobile source to form an efficient post combustion carbon dioxide capture, densification, and subsequent temporary on-board storage using waste heat recovered from an internal combustion engine (e.g., FIG. 2). One advantage of mobile applications for reducing carbon dioxide emissions over stationary applications is the availability of a large amount of relatively high to moderate temperature waste heat, which may be used to perform solvent regeneration, thereby allowing the continuous carbon dioxide absorption/capture, solvent regeneration, as well as carbon dioxide densification.

FIG. 2 shows an exhaust gas carbon dioxide capture and recovery system 11 in accordance with one or more embodiments of the present disclosure. In one or more embodiments, the exhaust gas carbon dioxide capture and recovery system 11 may be in an engine exhaust stream and designed to capture emitted carbon dioxide with minimal energy penalty by integration of the heating, cooling, and power systems. The exhaust gas carbon dioxide capture and recovery system 11 of FIG. 2 includes an absorption heat transformer 15 and a Mobile Carbon Capture (MCC) system 17. As can be appreciated by one skilled in the art, the components of the exhaust gas carbon dioxide capture and recovery system 11 may include inlets and outlets, and flow paths may connect the outlets and inlets of the components.

The exhaust gas carbon dioxide capture and recovery system 11 is connected to an internal combustion engine 19. In particular, the internal combustion engine 19 is directly connected to both the absorption heat transformer 15 and the MCC system 17 by one or more flow paths. During operation of the internal combustion engine 19, the internal combustion engine 19 produces an engine exhaust, herein referred to as a first exhaust 21. The first exhaust 21 is subsequently provided to the MCC system 17. The first exhaust 21 may contain carbon dioxide, water, unburned hydrocarbons, nitrogen oxide, and/or other impurities. As such, in one or more embodiments the first exhaust 21 may pass through an aftertreatment system (not shown) prior to being received by the MCC system 17. Further, in one or more embodiments, the first exhaust 21 may pass through a heat exchanger (not shown) in order to reduce the initial temperature of the first exhaust 21 prior to entering the MCC system 17. In addition, the heat exchanger may recover part of the heat content of the first exhaust 21 for later use in the process of the MCC system 17.

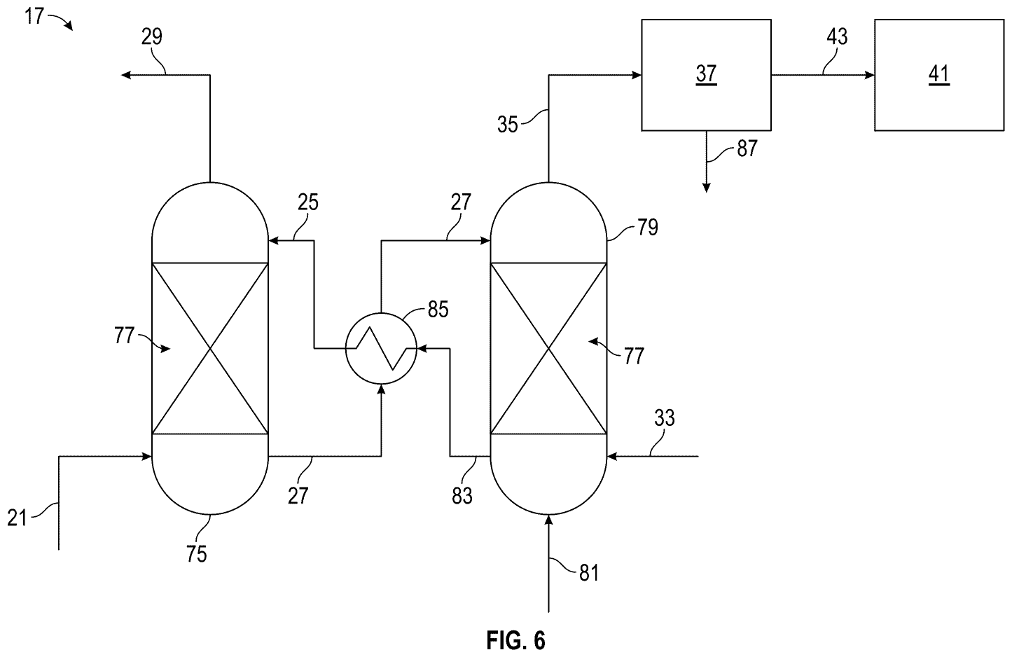

FIG. 3 shows a simplified flow diagram of an MCC system 17 according to one or more embodiments herein. In general, FIG. 3 shows a diagram of the major stages of an MCC system 17, according to embodiments herein. At the MCC system 17, the first exhaust 21 or a portion thereof, is provided to an absorption zone 23 of the MCC system 17. Within the absorption zone 23, the first exhaust 21 is first contacted with a liquid solvent capturing agent across a liquid gas contactor (e.g., FIG. 6). Examples of the liquid gas contactor that may be used in one or more embodiments include a packed column, membrane-type contactor, or rotating packed bed contactor.

Further, within the absorption zone 23, a carbon dioxide lean solvent 25 capturing agent absorbs carbon dioxide from the first exhaust 21, thereby separating the carbon dioxide from the first exhaust 21 to form a carbon dioxide rich solvent 27 and a second exhaust 29 having a reduced carbon dioxide content as compared to the first exhaust 21. As used herein, lean solvent 25 refers to a solvent having a diminished carbon dioxide content, suitable for absorbing carbon dioxide from an exhaust gas, such as tail pipe exhaust or exhaust gas recirculation (EGR) exhaust. A rich solvent 27 refers to a solvent having an enhanced carbon dioxide content following absorption of the carbon dioxide from the first exhaust 21.

The resulting rich solvent 27 may then be processed in a desorption or “regeneration” zone 31 of the MCC system 17 to separate the carbon dioxide from the rich solvent 27. In the desorption zone 31, the rich solvent 27 may be contacted, directly and/or indirectly, with one or more heat inputs 33, to reduce the capacity of the rich solvent 27 for retaining carbon dioxide, thereby producing a crude carbon dioxide vapor 35 and a lean solvent stream 25, which may be fed for continued use in the absorption zone 23.

The crude carbon dioxide vapor 35 recovered in the desorption zone 31 may then enter the densification zone 37. Densification may include compression and/or cooling of the captured carbon dioxide, for example. Power 39 for the compression of the carbon dioxide may be provided, for example, from the internal combustion engine 19 or a turbo-compounding device. Following densification, the condensed carbon dioxide 43 may be transported to an on-board storage tank 41 for later carbon dioxide utilization and/or disposal. The process of an MCC system 17 of an exhaust gas carbon dioxide capture and recovery system 11 is further detailed in FIG. 6.

Non-limiting examples of heat inputs 33 include hot engine exhaust, engine EGR, and hot engine coolant. In addition, as seen in FIG. 2, the absorption heat transformer 15 of the exhaust gas carbon dioxide capture and recovery system 11 provides heat to the MCC system 17.

As seen in FIG. 2 and noted above, the internal combustion engine 19 is also in communication with the absorption heat transformer 15. In particular, the absorption heat transformer 15 receives high temperature coolant 45 from the internal combustion engine 19. In one or more embodiments, an intermediate heat transfer loop may be formed between the internal combustion engine 19, the absorption heat transformer 15, and an engine coolant system 47.

Within this intermediate heat transfer loop, a recirculating heat exchange fluid, such as a coolant 49 (e.g., engine coolant, oil, or another suitable heat transfer fluid) is provided to the internal combustion engine 19 from the engine coolant system 47. Subsequently, heat is provided to the coolant 49 by the internal combustion engine 19 resulting in a high temperature coolant 45. As such, the high temperature coolant 45 having a first temperature is received and utilized by the absorption heat transformer 15 from the internal combustion engine 19. The heated coolant 45 is cooled by the absorption heat transformer 15. Subsequently the cooled coolant 49 is returned to the engine coolant system 47 at a second temperature. Accordingly, the first temperature is greater than the second temperature. The engine coolant system 47 may be any engine coolant system 47 known to those of ordinary skill in the art and may include a radiator, a coolant pump, and/or a radiator fan.

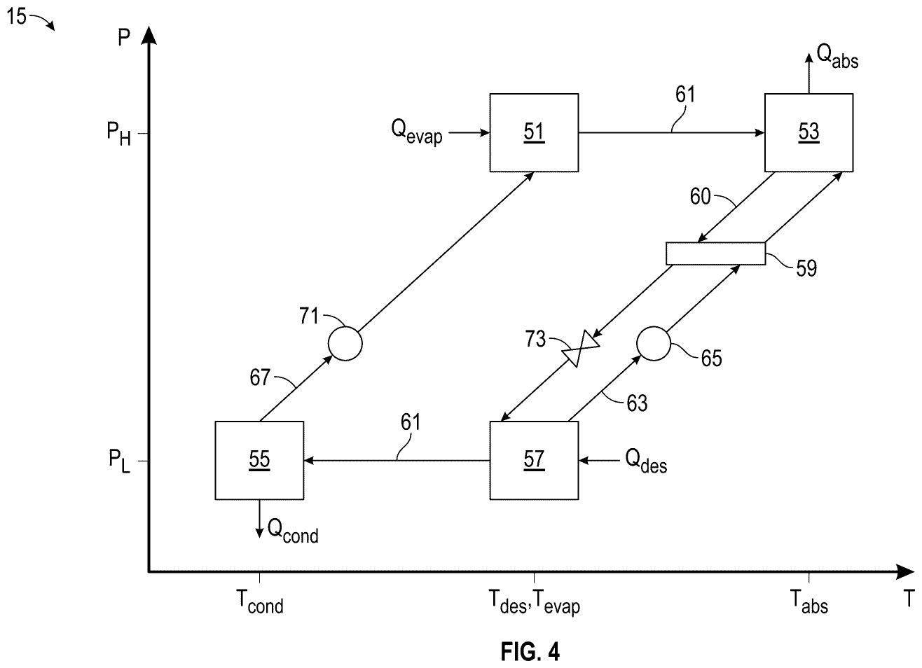

An absorption heat transformer 15 in accordance with one or more embodiments of the present disclosure in shown in FIG. 4. Here, in this non-limiting example, the absorption heat transformer 15 is a single stage absorption heat transformer, otherwise referred to as a type II absorption heat pump. However, in one or more embodiments, the absorption heat transformer 15 may be embodied as a double stage absorption heat transformer, a double effect absorption heat transformer, or a triple absorption heat transformer. The absorption heat transformer 15 of FIG. 4 includes an evaporator 51, an absorber 53, a condenser 55, a desorber 57 or “generator,” and an economizer 58 or “solution heat exchanger.” In addition, the absorption heat transformer 15 utilizes a working fluid. The working fluid is a mixture of an absorbent fluid and a refrigerant fluid.

During operation of the absorption heat transformer 15, thermal energy Q_{des} at an intermediate temperature T_{des} (e.g., waste heat) is supplied to a working fluid (i.e., a diluted or “weak” solution 60) within the desorber 57 at a low-pressure P_{L}. The provided thermal energy entering the desorber Q_{des} vaporizes part of the working fluid from the absorbent fluid, thereby producing a pure refrigerant vapor stream 61 and a liquid mixture stream with a high absorber concentration (i.e., a “strong” solution 63). The pure refrigerant vapor stream 61 flows from the desorber 57 to the condenser 55, and the strong solution 63 is pumped by a first pump 65 from the desorber 57 to the absorber 53 at a high-pressure zone P_{H}. That is, the first pump 65 increases the pressure of the strong solution 63 prior to the strong solution 63 entering the absorber 53.

At the condenser 55, the pure refrigerant vapor stream 61 is condensed into a pure refrigerant liquid stream 67. Consequently, an amount of heat Q_{cond} at a temperature T_{cond} is output to a low temperature heat sink. In one or more embodiments, the heat Q_{cond} is output to the environment. Alternatively, in one or more embodiments, the heat Q_{cond} is fed to the internal combustion engine 19 by way of a hot cooling air 69 as shown in FIG. 2.

In one or more embodiments, the pure refrigerant vapor stream 61 in the condenser 55 is cooled by the ambient air of the environment. The condensed pure refrigerant liquid stream 67 is pumped by a second pump 71 from the condenser 55 to the evaporator 51 at the high-pressure zone P_{H}. As such, the second pump 71 increases the pressure of the pure refrigerant liquid stream 67 prior to the pure refrigerant liquid stream 67 entering the evaporator 51.

At the evaporator 51, the pure refrigerant liquid stream 67 is evaporated by a thermal energy Qₑᵥₐₚ which is added to the evaporator 51 at an intermediate temperature Tₑᵥₐₚ. As a result, the pure refrigerant liquid stream 67 is vaporized into a pure refrigerant vapor stream 61. Subsequently, the pure refrigerant vapor stream 61 travels to the absorber 53.

At the absorber 53, the pure refrigerant vapor stream 61 produced by the evaporator 51 is absorbed by the strong solution 63 previously pumped into the absorber 53 from the desorber 57 by the first pump 65. Prior to the strong solution 63 entering the absorber 53, the strong solution 63 is pumped through an economizer 58 by the first pump 65. In this way, the economizer 58 heats the strong solution 63 prior to the strong solution 63 entering the absorber 53. The absorption process within the absorber 53 produces a useful heat Q_{abs} at a higher temperature T_{abs}.

In one or more embodiments, a heat transfer loop (not shown) may be formed between the absorber 53 of the absorption heat transformer 15 and a stripper (e.g., FIG. 6) of MCC system 17. The heat transfer loop may include a heat exchanger (not shown) and a pump (not shown). Within this heat transfer loop, a recirculating heat exchange stream 80 (e.g., FIG. 2) is provided to the absorber 53 of the absorption heat transformer 15 from the MCC system 17. In turn, the useful heat Q_{abs} of the absorber 53 is utilized to heat the stream 80. The stream 80 is heated to become a high temperature stream 81 and is then fed to the stripper of the MCC system 17 to provide heat to the stripper. The process of the stripper is later detailed in FIG. 6. Ultimately, the stream 80 is returned to the absorber 53 of the absorption heat transformer 15 at a reduced temperature, and the process of the heat transfer loop is repeated.

In one or more embodiments, the stream 80 may be a solvent similar to the solvent of the MCC system 17. The makeup of the solvent of the MCC system 17 is further described in regard to FIG. 6. Alternatively, in one or more embodiments, the stream 80 may be a high-temperature tolerant coolant, such as engine coolant, oil, or another suitable heat transfer fluid.

In addition, to the useful heat Q_{abs}, the weak solution 60 is produced by the absorption process within the absorber 53. Subsequently, the weak solution 60 exits the absorber 53 and is passed through the economizer 58. At the economizer 58, the strong solution 63 disposed within the economizer 58 while traveling from the first pump 65 to the absorber 53 is preheated by exchange with the weak solution 60 exiting the absorber 53. After exiting the economizer 58, the weak solution 60 passes through an expansion valve 73. The expansion valve 73 reduces the pressure of the weak solution 60 to the low-pressure P_{L} prior to the weak solution 60 reentering the desorber 57. The cycle restarts once the desorber 57 receives the weak solution 60.

In one or more embodiments, the thermal energy or waste heat provided to the desorber 57 and the evaporator 51 (i.e., Q_{des} and Qₑᵥₐₚ) may be provided by the heat content of the heated coolant 45 received from the internal combustion engine 19. The heated coolant 45 is provided to the desorber 57 and evaporator 51 at a first temperature ranging from 80° C.-100° C. In one or more embodiments, the first temperature is slightly higher than Tₑᵥₐₚ and T_{des}. In FIG. 4, heated coolant 45 enters the desorber 57 and the evaporator 51 at a first temperature of 90° C. and is cooled to a second temperature of 80° C. within the desorber 57 and the evaporator 51. In one or more embodiments, the evaporator temperature Tₑᵥₐₚ may be 5° C. less than the desorber temperature T_{des} and 10° C. less than the first temperature of the heated coolant 45.

As stated above, in one or more embodiments, ambient air of the environment may be utilized by the condenser 55 to condense the pure refrigerant vapor stream 61. In particular, ambient air enters the condenser 55 and is heated to form the hot cooling air 69 (e.g., FIG. 2) that is fed to the internal combustion engine 19. In FIG. 4, ambient air enters the condenser 55 at a temperature of 30° C. and the hot cooling air 69 exits the condenser 55 at a temperature of 40° C.

The absorbent fluid and the refrigerant fluid making up the working fluid may vary depending on the process conditions and the targeted performance of the absorption heat transformer 15. In FIG. 4, the absorbent fluid and the refrigerant fluid of the working fluid may be lithium bromide and water, respectively. In one or more embodiments, the absorbent fluid and the refrigerant fluid of the working fluid may be water and ammonia, respectively. In addition, in one or more embodiments, the absorbent fluid may be dimethylacetamide (DMAC), dimethyl glycol (DMEDEG), or dimethylethylenurea (DMEU). In one or more embodiments, the refrigerant fluid may be R134a (CH2FCF3) and R124 (CHClFCF3).

Further, in the non-limiting example of FIG. 4, the low-pressure P_{L} and high-pressure P_{H} are 5 kPa and 50 kPa, respectively. To this end, in this non-limiting example, the temperature of the stream 80 entering the absorber 53 is increased from 120° C. to 130° C. within the absorber 53 by the useful heat Q_{abs} having a temperature T_{abs} of 140° C.

The energetic performance level of the absorption cycle of the absorption heat transformer 15 is assessed by a coefficient of performance (COP). The COP measures the efficiency of the absorption heat transformer 15 transferring heat from an intermediate temperature level (i.e., Q_{des} and Qₑᵥₐₚ) to a high temperature level (i.e., Q_{abs}), and may be defined by the formula:

$$C O P = \frac{- {Q}_{abs}}{{Q}_{des} + {Q}_{evap}} \qquad ( 1 )$$

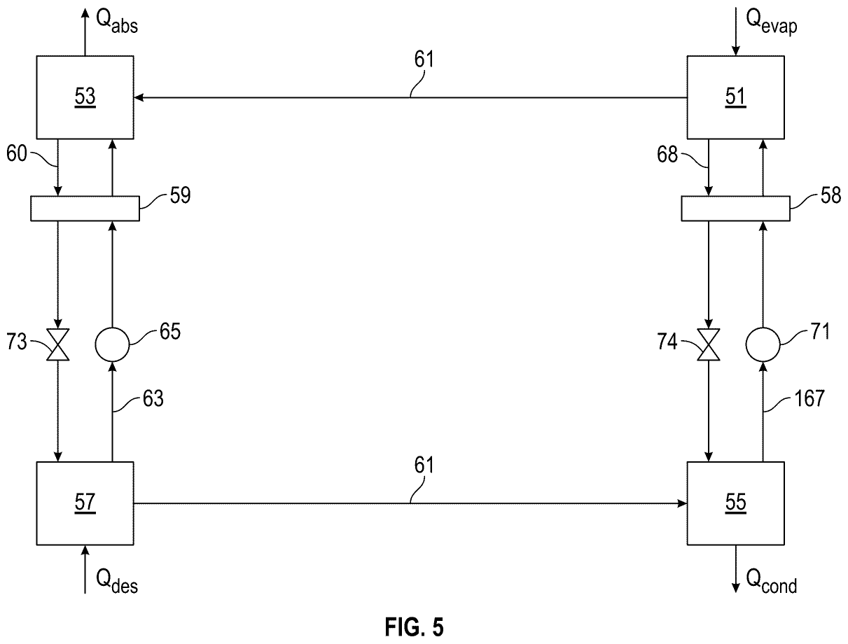

The COP of absorption heat transformers 15 were evaluated using simulator software, such as Aspen Plus. For example, the COP of an absorption heat transformer 15 of FIG. 5 was simulated. Similar to the absorption heat transformer 15 of FIG. 4, the absorption heat transformer 15 of FIG. 5 includes an evaporator 51, an absorber 53, a condenser 55, a desorber 57, first economizer 58, a first pump 65, and a first expansion valve 73. Additionally, the absorption heat transformer 15 of FIG. 5 includes a second economizer 59, a second pump 71, and a second expansion valve 74.

The COP of the example absorption heat transformer 15 depicted in FIG. 5 was simulated utilizing the electrolyte ‘ELECNRTL’ method in Aspen Plus V12. During this aforementioned simulation, solid lithium bromide (LiBr), water (H₂O), lithium ion (Li⁺), bromide anion (Br), hydroxide anion (OH⁻), and hydrogen ion (H₃O⁺) were considered and readily taken from the Aspen Plus V12 library. The chemical reactions considered were an equilibrium reaction:

$$2 {H}_{2} O ↔ {H}_{3} {O}^{+} + {OH}^{-} \qquad ( 2 )$$

and a salt reaction:

$$LiBr ↔ {Li}^{+} + {Br}^{-} \qquad ( 3 )$$

Within the software of the exemplary simulation, the exchanger ‘HEATER’ model was selected to regulate the absorber 53 and the condenser 55 of the absorption heat transformer 15 and the separator ‘FLASH’ model was selected to regulate the desorber 57 and the evaporator 51. In addition, the exchanger ‘HeatX’ model was selected to regulate the first economizer 58 and the second economizer 59, the pressure changer ‘PUMP’ model was selected to regulate the first pump 65 and the second pump 71, and the pressure changer ‘VALVE’ model was selected to regulate the first expansion valve 73 and the second expansion valve 74.

The absorption heat transformer 15 of FIG. 5 is similar to the absorption heat transformer 15 of FIG. 4 in that a strong solution 63 is circulated from the desorber 57 to the absorber 53, a weak solution 60 is circulated from the absorber 53 to the desorber 57, a pure refrigerant vapor stream 61 is circulated from the desorber 57 to the condenser 55, and a pure refrigerant vapor stream 61 is circulated from the evaporator 51 to the absorber 53. However, unlike the absorption heat transformer 15 of FIG. 4, the absorption heat transformer 15 of FIG. 5 considers a general case where the fluid between with the condenser 55 and the evaporator 51 is not a pure refrigerant but a weak solution composed of a mixture of the pure refrigerant fluid and an absorbent. Hence, the weak solution of FIG. 5 may not fully evaporate in the evaporator 51 and a strong solution 63 may exist in the evaporator 51. The absorption heat transformer 15 of FIG. 5 includes a second economizer 59 and a second expansion valve 74 in addition to the second pump 71 between the evaporator 51 and the condenser 55 to accommodate the strong solution 63. As such, at the condenser, the pure refrigerant 61 mixes with the strong solution 63 to form a condensed weak solution 167. If the concentration of the absorbent in the evaporator 51 and the condenser 55 side of the absorption heat transformer 15 is reduced to zero, the configuration of the absorption heat transformer 15 of FIG. 5 emulates the configuration of the absorption heat transformer 15 of FIG. 4.

At the condenser 55 of the absorption heat transformer 15 of FIG. 5, the pure refrigerant vapor stream 61 in the condenser 55 is mixed with the strong solution 63, cooled, and condensed to form the condensed weak solution 167. Subsequently, the condensed weak solution stream 67 is pumped by the second pump 71 from the condenser 55 to the evaporator 51. Meanwhile, at the evaporator 51, strong solution 63 is circulated from the evaporator 51 to the condenser 55. As such, the second economizer 59 promotes heat exchange between the strong solution 63 exiting the evaporator 51 and the condensed weak solution 167 being pumped by the second pump 71. In this way, the condensed weak solution 167 within the second economizer 59 is heated by exchange with the strong solution 63 within the second economizer 59 prior to the condensed weak solution 167 entering the evaporator 51. Further, upon exiting the second economizer 59, the strong solution 63 passes through the second expansion valve 74 which reduces the pressure of the strong solution 63 prior to the strong solution 63 entering the condenser 55.

Within the software of the exemplary simulation, lithium bromide was selected as the absorbent fluid and water was selected as the refrigerant fluid. Thus, the working fluid was a LiBr/H₂O mixture with the strong solution 63 being a rich LiBr/H₂O working fluid and the weak solution 60 being a lean LiBr/H₂O working fluid. The simulation of the absorption heat transformer 15 of FIG. 5 revealed a COP of approximately 40%. Specifically, the resulting COP was found using approximately 65% w/w (weight by weight) lithium bromide in water concentration in the strong solution 63 and approximately 63% w/w lithium bromide in water concentration in the weak solution 60.

Furthermore, the simulation of the absorption heat transformer 15 of FIG. 5 revealed that an absorbent fluid concentration of 0% is possible between the evaporator 51 and the condenser 55. That is, the stream exiting the condenser 55 contains only pure refrigerant instead of a weak solution, similar to the configuration of FIG. 4. Hence, total evaporation of the pure refrigerant at the evaporator is possible and there is no need to circulate a working fluid between the condenser 55 and the evaporator 51 as revealed by the simulation. Refrigerant fluid alone is enough to provide workable conditions. Thus, similar to the absorption heat transformer 15 of FIG. 4, there is no need for a second economizer 59 and a second expansion valve 74 between the evaporator 51 and the condenser 55 as total evaporation of the pure refrigerant liquid stream 67 is possible in the evaporator 51. Consequently, the absorption heat transformer 15 of the present invention may be significantly reduced in size, cost, and complexity compared to other type II absorption heat pumps in industrial applications.

In FIG. 6, additional details of the carbon dioxide absorption and desorption stages are provided. Specifically, FIG. 6 shows an exemplary embodiment of the absorption zone 23 and desorption zone 31 of an MCC system 17 according to one or more embodiments herein. As described above, a first exhaust 21 is fed to an exhaust absorber 75. In one or more embodiments, the first exhaust 21 may be cooled using a heat exchanger prior to entering the exhaust absorber 75. The exhaust absorber 75 may contain a bed of contact structures 77 providing a tortuous path for contact and interaction of the first exhaust 21 with a lean solvent 25 for absorption of carbon dioxide. Following absorption of at least a portion of the carbon dioxide from the first exhaust 21, a second exhaust 29 having a reduced carbon dioxide content is recovered from the exhaust absorber 75. During the absorption stage, the lean solvent 25 may be fed to the exhaust absorber 75 above the contact structure 77 and the rich solvent 27 may be recovered from a bottom of the exhaust absorber 75. Subsequently, the rich solvent 27 is then forwarded to a stripper 79 of the MCC system 17 for conducting a desorption step.

Within the stripper 79, the rich solvent 27 is heated to diminish its capacity for retaining carbon dioxide in a dissolved state. The stripper 79 may also contain a bed of contact structures 77 providing for contact of hot vapors with the rich solvent 27, aiding in the removal of carbon dioxide from the solvent. As described above, heat is provided to the stripper 79 from a high temperature stream 81 heated by the absorption heat transformer 15.

In one or more embodiments, one or more additional heat inputs 33 may be provided to the stripper 79 from various sources, such as from exhaust gases, a stand-alone boiler, electrical power generated by the internal combustion engine 19, or other heat sources available from the internal combustion engine 19. The heat input 33 may strip carbon dioxide from the rich solvent 27, allowing recovery of a crude carbon dioxide vapor 35 from a top of the stripper 79 and recovery of a hot lean solvent 83 from a bottom of the stripper 79.

In one or more embodiments, a system solvent loop may be formed between the stripper 79 and the exhaust absorber 75. That is, the stripper 79 may be coupled to the exhaust absorber 75 such that the stripper 79 is downstream of the exhaust absorber 75 for receiving the rich solvent stream 27 and upstream of the exhaust absorber 75 for providing the lean solvent stream 25 as shown in FIG. 6.

Due to the heat addition to the solvent during stripping, the lean solvent 83 recovered from the stripper 79 has an elevated temperature and thus has a diminished capacity for retaining carbon dioxide. A feed/effluent exchanger 85 may be used to cool the hot lean solvent 83 (thereby forming a cool lean solvent 25) while warming (i.e., pre-heating) the rich solvent 27 being fed from the exhaust absorber 75 to the stripper 79. In one or more embodiments, the cool lean solvent 25 may also pass through a trim cooler (not shown) to further cool the lean solvent 25 to the temperature of the exhaust absorber 75.

The crude carbon dioxide vapor 35 recovered from the stripper 79 may undergo downstream processing as noted above, including compression/liquefaction at the densification zone 37, removal of water 87, and storage at a carbon dioxide storage tank 41, among others. In one or more embodiments, a carbon dioxide compressor (not shown) coupled downstream of the stripper 79 may be employed to compress the crude carbon dioxide vapor 35 into a concentrated pressurized carbon dioxide product 43. The concentrated pressurized carbon dioxide product 43 may have a predetermined pressure (e.g., 1 to 150 bar) for storage or utilization. Carbon dioxide utilized on-board for ambient pressure applications may not require further compression, whereas carbon dioxide being transported off-board may require compression to densify the material. The treated exhaust gas stream having a reduced carbon dioxide content (i.e., the second exhaust 29) may be discharged into the atmosphere. The formation of dense carbon dioxide 43 for efficient on-board temporary storage may be accomplished by compression, liquefaction, or by freezing the gas to form solid carbon dioxide (i.e., dry ice).

As such, in some embodiments, an on-board carbon dioxide storage tank 41 may be permanently mounted to the mobile vehicle or vessel and coupled downstream of the densification zone 37 (i.e., downstream of the carbon dioxide compressor). In some other embodiments, the on-board carbon dioxide storage tank 41 may be detachable from the mobile vehicle or vessel and the exhaust gas carbon dioxide capture and recovery system 11. In yet some other embodiments, a combination of permanent and detachable tanks may be used. The construction of the on-board carbon dioxide storage tank 41 may favor lighter-weight materials to reduce the overall weight of the exhaust gas carbon dioxide capture and recovery system 11. Such materials may include alloys of steel, aluminum, or titanium, polymers, and composite materials, such as fiber glass and carbon fiber.

In one or more embodiments, the MCC system 17 may be a Temperature Swing Adsorption (TSA) based MCC system 17. That is, the regeneration of the solvent capturing agent may be a TSA process. In a TSA process, circulation of the solvent occurs continuously so that the solvent is never saturated. In addition, the solvent may at different times and locations either absorb carbon dioxide and become the rich solvent 27 or desorb the carbon dioxide and become the lean solvent 25.

For an MCC system 17, the solvent employed must meet several design requirements. Due to the compact and mobile nature of the MCC system 17, solvents having relatively high cyclic carbon dioxide carrying capacity, a fast rate of reaction with carbon dioxide, and a relatively significant heat of absorption would permit relatively reduced liquid solvent circulation rates, greater carbon dioxide capture rates, and allow for solvent regeneration at greater pressures than in static and larger systems. Less solvent also has a capital impact on the MCC system 17, permitting a smaller stripper 79, exhaust absorber 75, heat exchangers, pumps, and other ancillary system equipment.

Solvents useful for the MCC system 17 include aqueous solutions of water-soluble amines, amino acids, alkaline salts, and combinations thereof. Examples of useful water-soluble amines include, but are not limited to, monoethanolamine (MEA), diethanolamine (DEA), methyl diethanolamine, piperazine and its derivatives (for example, 1-methyl-piperazine, 2-methyl-piperazine, N-aminoethyl-piperazine), morpholine, 2-amino-2-methyl-propanol, diisopropanolamine, ethylenediamine, hexamethylenediamine, and combinations thereof. Other water-soluble amines may be primary, secondary, or tertiary amines, and combinations thereof. For example, the system solvent may include MEA in a range of from about 5 to about 10 molar concentration (M) in water.

Examples of useful amino acids include, but are not limited to, Group One salts of amino and amino sulfonic acids, such as alpha alanine, beta alanine, taurine, 2-amino-2-methyl-propionate, N-methyl-L-alanine, homotaurine, proline, serine, glycine, and combinations thereof. “Group One” is defined as Group I of the Periodic Table of Elements, including, but not limited to, sodium and potassium. Further examples of useful amino acids include, but are not limited to, Group One salts of primary, secondary, and tertiary amino and amino-sulfonic acids, and combinations thereof. Primary and secondary amino acid solvents may have reduced volatility, reduced toxicity, better biodegradability, a faster rate of reaction, and greater heat absorption than other carbon dioxide absorbing solvents.

Examples of useful alkaline salts include, but are not limited to, Group One and Group Two alkaline salts, and combinations thereof. “Group Two” is defined similarly as Group One (i.e., meaning Group II of the Periodic Table). For example, potassium, calcium, and sodium carbonates, and mixtures thereof, in water are useful system solvents.

In some instances, the solvent is alkaline in pH (i.e., having a pH in a range from about 8 to about 12). In some instances, the system solvent is configured such that it is operable to absorb carbon dioxide at about 40° C. (i.e., 20° C. to 60° C. in various embodiments) and to desorb the carbon dioxide at a temperature equal to or greater than about 90° C. (i.e., 80° C. to 200° C. in various embodiments, such as 95° C. to 120° C. in some embodiments).

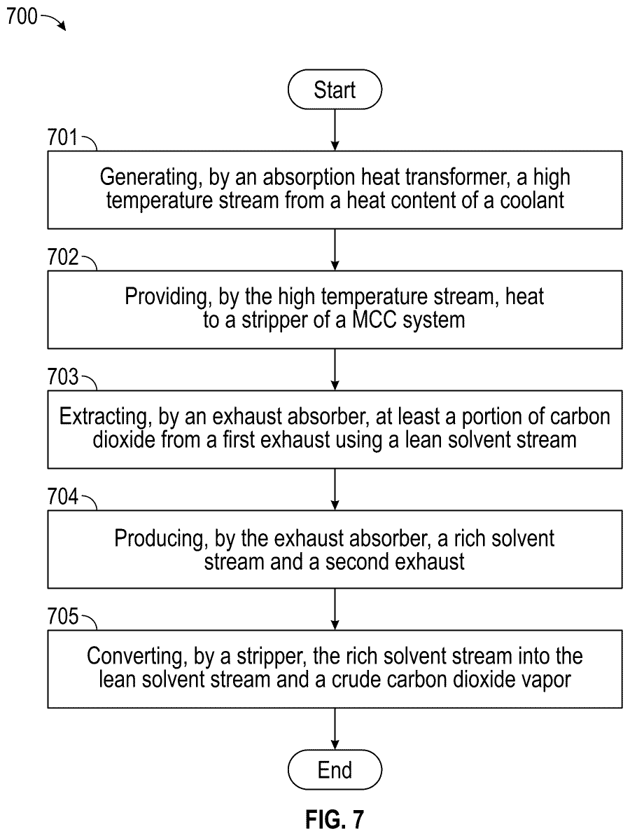

FIG. 7 depicts a flowchart 700 showing a method for capturing and recovering carbon dioxide from an internal combustion engine 19. While the various flowchart blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In block 701, a high temperature stream 81 is generated by an absorption heat transformer 15 from the heat content of a high temperature coolant 45. In one or more embodiments, the absorption heat transformer 15 may be a single stage absorption heat transformer (i.e., a type II absorption heat pump). The absorption heat transformer 15 includes an evaporator 51, an absorber 53, a condenser 55, a desorber 57, and an economizer 58, and utilizes a working fluid formed of a mixture of an absorbent fluid and a refrigerant fluid.

During operation, the desorber 57 is provided the heated coolant 45 from the internal combustion engine 19 at a first temperature. The heat content of the heated coolant 45 is supplied to a working fluid within the desorber 57 at a low-pressure P_{L}. The provided thermal energy entering the desorber Q_{des} produces a pure refrigerant vapor stream 61 and a strong solution 63 by vaporizing a portion of the working fluid from the absorbent fluid. The pure refrigerant vapor stream 61 flows from the desorber 57 to the condenser 55, and the strong solution 63 is pumped by a first pump 65 from the desorber 57 to the absorber 53 at a high-pressure zone P_{H}.

At the condenser 55, the pure refrigerant vapor stream 61 is condensed into a pure refrigerant liquid stream 67. Consequently, an amount of heat Q_{cond} at a temperature T_{cond} is output to a low temperature heat sink. In one or more embodiments, the heat Q_{cond} is output to the environment. Alternatively, in one or more embodiments, the heat Q_{cond} is fed to the internal combustion engine 19 by way of a hot cooling air 69.

The condensed pure refrigerant liquid stream 67 is pumped by a second pump 71 from the condenser 55 to the evaporator 51 at the high-pressure zone P_{H}. At the evaporator 51, the pure refrigerant liquid stream 67 is evaporated by a thermal energy Qₑᵥₐₚ. The thermal energy Qₑᵥₐₚ is added to the evaporator 51 from the heat content of the heated coolant 45. That is, the evaporator 51 is supplied the heated coolant 45 from the internal combustion engine 19. As a result, the pure refrigerant liquid stream 67 is vaporized into a pure refrigerant vapor stream 61. Subsequently, the pure refrigerant vapor stream 61 travels to the absorber 53.

At the absorber 53, the pure refrigerant vapor stream 61 produced by the evaporator 51 is absorbed by the strong solution 63 previously pumped into the absorber 53 from the desorber 57 by the first pump 65. Prior to the strong solution 63 entering the absorber 53, the strong solution 63 is pumped through the economizer 58 by the first pump 65. In this way, the economizer 58 heats the strong solution 63 prior to the strong solution 63 entering the absorber 53. The absorption process within the absorber 53 produces a useful heat Q_{abs} at a higher temperature T_{abs} and the weak solution 60. The weak solution 60 then exits the absorber 53 and is passed through the economizer 58.

At the economizer 58, the strong solution 63 disposed within the economizer 58 while traveling from the first pump 65 to the absorber 53 is preheated by exchange with the weak solution 60 exiting the absorber 53. After exiting the economizer 58, the weak solution 60 passes through an expansion valve 73. The expansion valve 73 reduces the pressure of the weak solution 60 to the low-pressure P_{L} prior to the weak solution 60 reentering the desorber 57. Ultimately, the cycle restarts once the desorber 57 receives the weak solution 60.

The useful heat Q_{abs} produced by the absorption process is utilized to increase the temperature of a recirculating heat exchange stream 80 of a heat transfer loop formed between the absorber 53 and a stripper 79 of MCC system 17. The stream 80 is heated by the useful heat Q_{abs} to produce a high temperature stream 81. In one or more embodiments, the recirculating heat exchange stream 80 is a high-temperature tolerant coolant (e.g., engine coolant, oil, or another suitable heat transfer fluid).

In block 702, the high temperature stream 81 is supplied to the stripper 79 of the MCC system 17, thereby providing heat to the stripper 79. That is, the high temperature stream 81 is fed to the stripper 79 by the heat transfer loop between the absorber 53 and the stripper 79. In one or more embodiments, the heat transfer loop includes at least a heat exchanger and/or a pump.

The MCC system 17 is employed to capture carbon emissions from a first exhaust 21 of the internal combustion engine 19. In block 703, the first exhaust 21 is supplied to an absorption zone 23 of the MCC system 17. Within the absorption zone 23, the first exhaust 21 is contacted with a liquid solvent capturing agent across a liquid gas contactor 77 of an exhaust absorber 75. In addition, a lean solvent 25 absorbs carbon dioxide from the first exhaust 21 within the exhaust absorber 75.

In block 704, following the absorption of at least a portion of the carbon dioxide from the first exhaust 21, a second exhaust 29 having a reduced carbon dioxide content and a rich solvent 27 having an enhanced carbon dioxide content are formed. The second exhaust 29 may subsequently be released into the atmosphere.

In block 705, the resulting rich solvent 27 is then processed within a stripper 79 of a desorption zone 31 of the MCC system 17. Within the stripper 79, the rich solvent 27 may be contacted with one or more heat inputs 33 to strip the rich solvent 27 of carbon dioxide, thereby producing a crude carbon dioxide vapor 35 and a lean solvent stream 25. As described above, the stripper 79 is heated by the high temperature stream 81 from the absorption heat transformer 15. In one or more embodiments, the stripper 79 may also receive additional heat input 33 from sources, such as exhaust gases, a stand-alone boiler, electrical power generated by the internal combustion engine 19, or other heat sources available from the internal combustion engine 19.

The lean solvent stream 25 produced by the stripper 79 may be fed back to the exhaust absorber 75 for continued use in absorption zone 23. The crude carbon dioxide vapor 35 recovered in the desorption zone 31 may then undergo densification. Subsequently, the dense carbon dioxide 43 may be transported to an on-board carbon dioxide storage tank 41 for later carbon dioxide utilization and/or sequestration.

Accordingly, the aforementioned embodiments as disclosed relate to exhaust gas carbon dioxide capture and recovery system 11 and methods useful for capturing and recovering carbon dioxide from an internal combustion engine 19. The disclosed exhaust gas carbon dioxide capture and recovery systems 11 and methods advantageously reduce the overall carbon intensity of an internal combustion engine 19 by capturing a large percentage of carbon dioxide from an exhaust of the internal combustion engine 19. In addition, the disclosed exhaust gas carbon dioxide capture and recovery systems 11 and methods advantageously employ an absorption heat transformer 15 to provide upgraded heat to a stripper 79 of an MCC system 17. As such, the disclosed exhaust gas carbon dioxide capture and recovery systems 11 and methods permit an increase in the achievable carbon capture rate by providing additional heat to the MCC system 17 without the need to burn extra fuel.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed is:

1. An exhaust gas carbon dioxide capture and recovery system for an internal combustion engine, the system comprising:
a Mobile Carbon Capture (MCC) system configured capture carbon emissions of a first exhaust of the internal combustion engine, the MCC system comprising:
an exhaust absorber configured to extract at least a portion of carbon dioxide from the first exhaust using a lean solvent stream, and to produce a rich solvent stream and a second exhaust having a reduced amount of carbon dioxide, the lean solvent stream comprising a solvent selective for absorbing carbon dioxide, and the rich solvent stream comprising the solvent and absorbed carbon dioxide; and
a stripper configured to convert the rich solvent stream into the lean solvent stream and a crude carbon dioxide vapor; and
an absorption heat transformer configured to provide heat to the stripper by generating a high temperature stream from a heat content of a coolant, the high temperature stream having a temperature greater than the coolant.

2. The system according to claim 1, wherein the MCC system further comprises:
a carbon dioxide compressor configured to convert the crude carbon dioxide vapor into a concentrated pressurized carbon dioxide product, the carbon dioxide compressor being coupled downstream of the stripper; and
a carbon dioxide storage tank configured to both receive and store the concentrated pressurized carbon dioxide product, the carbon dioxide storage tank being coupled downstream of the carbon dioxide compressor.

3. The system according to claim 1, wherein the stripper further receives additional heat content provided by at least one of the following:
the first exhaust;
the coolant; and
a boiler.

4. The system according to claim 1, wherein the absorption heat transformer receives the coolant from the internal combustion engine at a first temperature and feeds an engine coolant system the coolant at a second temperature.

5. The system according to claim 1, wherein the system is mounted on a mobile vehicle or vessel.

6. The system according to claim 1, wherein the stripper is coupled to the exhaust absorber using a system solvent loop such that the stripper is downstream of the exhaust absorber for receiving the rich solvent stream and upstream of the exhaust absorber for providing the lean solvent stream.

7. The system according to claim 6, wherein the MCC system is a Temperature Swing Adsorption (TSA) based MCC system.

8. The system according to claim 1, wherein absorption heat transformer device comprises:
a desorber;
an evaporator;
an absorber;
a condenser; and
a working fluid, the working fluid being a mixture of a refrigerant fluid and an absorber fluid.

9. The system according to claim 8, wherein the absorption heat transformer further comprises:
a first pump configured to pump a strong solution of the working fluid from the desorber to the absorber;
a second pump configured to pump the refrigerant fluid of the working fluid from the condenser to the evaporator;
an economizer disposed between the first pump and the absorber; and
an expansion valve disposed between the economizer and the desorber.

10. The system according to claim 8, wherein the refrigerant fluid is at least one of the following:
water;
ammonia;
R134a; and
R124.

11. The system according to claim 8, wherein the absorber fluid is at least one of the following:
water;
lithium bromide;
dimethylacetamide;
dimethyl glycol; and
dimethylethylenurea.

12. A method for capturing and recovering carbon dioxide from an internal combustion engine, the method comprising:
generating, by an absorption heat transformer, a high temperature stream from a heat content of a coolant;
providing, by the high temperature stream, heat to a stripper of a Mobile Carbon Capture (MCC) system, the MCC system being configured to capture carbon emissions of a first exhaust of the internal combustion engine;
extracting, by an exhaust absorber of the MCC system, at least a portion of carbon dioxide from the first exhaust using a lean solvent stream, the lean solvent stream comprising a solvent selective for absorbing carbon dioxide;
producing, by the exhaust absorber, a rich solvent stream and a second exhaust having a reduced amount of carbon dioxide, the rich solvent stream comprising the solvent and absorbed carbon dioxide; and
converting, by the stripper of the MCC system, the rich solvent stream into the lean solvent stream and a crude carbon dioxide vapor.

13. The method according to claim 12, further comprising converting, by a carbon dioxide compressor of the MCC system, the crude carbon dioxide vapor into a concentrated pressurized carbon dioxide product.

14. The method according to claim 13, further comprising receiving and storing, by a carbon dioxide storage tank of the MCC system, the concentrated pressurized carbon dioxide product.

15. The method according to claim 12, further comprising:
providing, by the internal combustion engine, the coolant at a first temperature to the absorption heat transformer; and
providing, by the absorption heat transformer, the coolant at a second temperature to an engine coolant system.

16. The method according to claim 12, further comprising providing the stripper with additional heat content by at least one of the following:
the first exhaust;
the coolant; and
a boiler.

17. The method according to claim 12, further comprising:
providing the heat content of the coolant to a desorber and an evaporator of the absorption heat transformer; and
providing, by a condenser of the absorption heat transformer, a hot cooling air generated from the heat content of the coolant to the internal combustion engine.

18. The method according to claim 12, wherein generating the high temperature stream from the heat content of the coolant comprises producing, by an absorption process of an absorber of the absorption heat transformer, a useful heat having a temperature greater than a temperature of the coolant.

19. The method according to claim 12, further comprising discharging the second exhaust into an environment of the MCC system.

20. The method according to claim 12, wherein the MCC system is a Temperature Swing Adsorption (TSA) based MCC system such that the solvent is continuously circulated, thereby preventing the solvent from saturating.
